(19) United States
(12) Patent Application Publication
(10) Pub. No.: US 2016/0052337 A1
(43) Pub. Date: Feb. 25, 2016

(54) ANTI-SLIP DEVICE FOR A HUB OF A BICYCLE

(71) Applicant: Tseng-Ping TIEN, Taipei City (TW)

(72) Inventor: Tseng-Ping TIEN, Taipei City (TW)

(73) Assignee: FOSS WORLDWIDE INC., Taichung City (TW)

(21) Appl. No.: 14/753,711

(22) Filed: Jun. 29, 2015

(30) Foreign Application Priority Data
Aug. 21, 2014 (TW) 103214938

(51) Int. Cl. B60B 27/02; F16D 41/24

(52) U.S. Cl. CPC B60B 27/023; F16D 41/24

(57) ABSTRACT

An anti-slip device for a hub of a bicycle is provided for a first engaging element and a second engaging element between a bicycle hub and a chain wheel drive seat of the bicycle. A second engaging element has one side facing the chain wheel drive seat and including indentations equally defined therein. Each indentation has a bottom and a protrusion extending from one end of the bottom, wherein protrusion has a shoulder and a distal end. The chain wheel drive seat has multiple curved control blocks laterally extending therefrom, wherein the multiple curved control blocks are annularly arranged. Each curved control block is movably received in a corresponding one of the indentations and a circle difference is formed between the corresponded curved control block and the indentation.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to an anti-slip device, and more particularly to an anti-slip device for a hub of a bicycle.

2. Description of Related Art Including Information Disclosed Under 37 CFR 1.97 and 37 CFR 1.98.

The unidirectional ratchet structure for a hub of a bicycle is divided into two types including longitudinally side-by-side engaging mold and radial engaging mold, however, the radial engaging mold does not relate to the present invention. A conventional longitudinally side-by-side engaging structure includes two ratchet element engaged to each other and a spring compressively abuts a corresponding one of the two ratchet elements for the two ratchet elements being rotated together to drive the hub. The two ratchet elements are dislocated to each other and the spring is compressed when the hub is idle. The conventional longitudinally side-by-side engaging structure can provide a great engaging area and a drive effect. However, the depth of the ratchet on each of the ratchet element is small, about 0.8 mm, such that the ratchet may moved over a corresponding ratchet on the other ratchet element when the acting force between the two ratchet elements is great such that the two ratchet elements are idle to each other. Consequently, the driving effect for the bicycle is low and it is very dangerous when the bicycle is moved uphill.

The present invention has arisen to mitigate and/or obviate the disadvantages of the conventional driving structure for bicycle hub.

### BRIEF SUMMARY OF THE INVENTION

The main objective of the present invention is to provide an improved a device for a hub of a bicycle, which is anti-slip.

To achieve the objective, the anti-slip device for a hub of a bicycle in accordance with the present invention provided for a first engaging element and a second engaging element between a bicycle hub and a chain wheel drive seat of the bicycle, wherein the first engaging element and the second engaging element respectively include a first teethed face and a second teethed face that are exactly engaged with each other for driving the bicycle hub. The first engaging element is mounted onto one side of the bicycle hub and the second engaging element is axially movably received in the chain wheel drive seat, wherein the second engaging element is automatically engaged to the first engaging element due to a resume structure that is disposed between the first engaging element and the second engaging element. The second engaging element has one side facing the chain wheel drive seat and including indentations equally defined therein. Each indentation has a bottom and a protrusion extending from one end of the bottom, wherein protrusion has a shoulder and a distal end. The chain wheel drive seat has multiple curved control blocks laterally extending therefrom, wherein the multiple curved control blocks are annularly arranged. Each curved control block is movably received in a corresponding one of the indentations and a circle difference is formed between the corresponded curved control block and the indentation. A top of the curved control block abuts against the bottom of the corresponding indentation and engaged to the distal end of the protrusion when the first teethed face of the first engaging element and the second teethed face of the second engaging element are dislocated and the second engaging element is backward moved relative to the first engaging element. The top of the curved control block is disengaged from the distal end and moved along the circle difference to engaged to the shoulder such that the second engaging element cannot be backward moved relative to the first engaging element when the second teethed face is engaged to the first teethed face to prevent the bicycle hub from being idle.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is an exploded perspective view of an anti-slip device for a hub of a bicycle in accordance with the present invention.

FIG. 2 is another exploded perspective view of an anti-slip device for a hub of a bicycle in accordance with the present invention.

FIG. 3 is a first operational view of the anti-slip device in accordance with the present invention.

FIG. 4 is a second operational view of the anti-slip device in accordance with the present invention.

FIG. 5 is a second embodiment of the anti-slip device for a hub of a bicycle in accordance with the present invention.

### DETAILED DESCRIPTION OF THE INVENTION

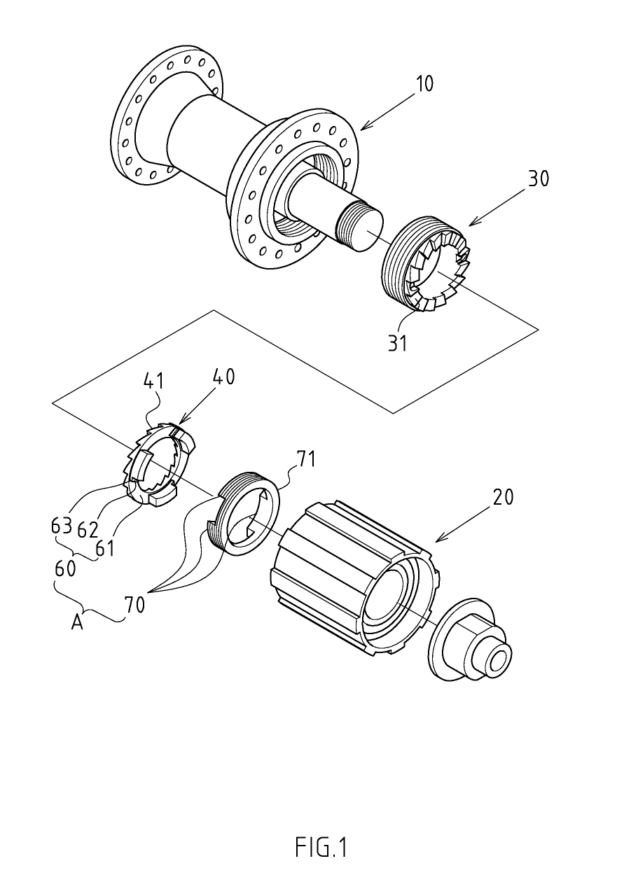

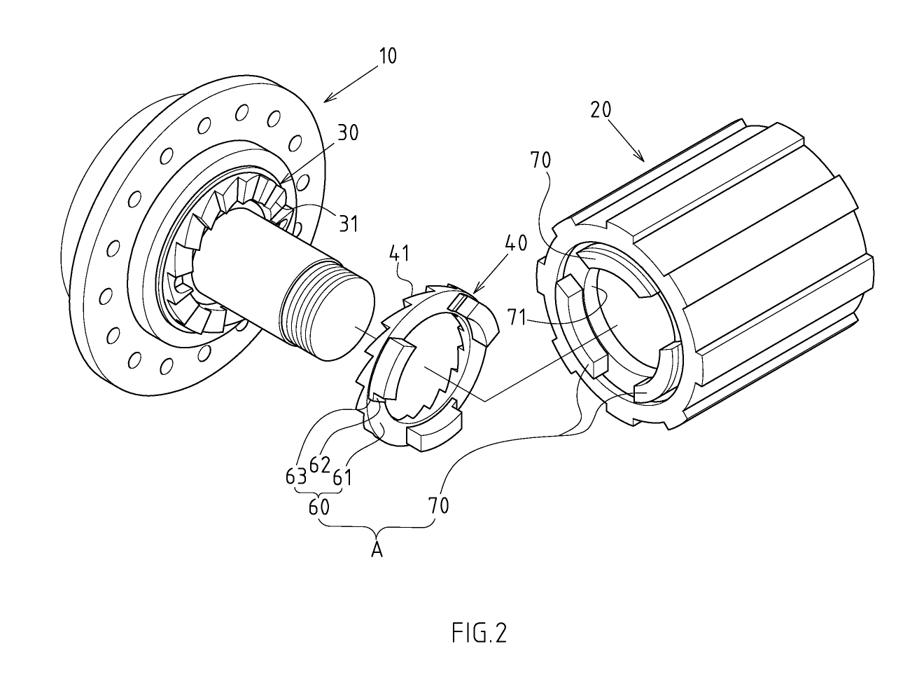

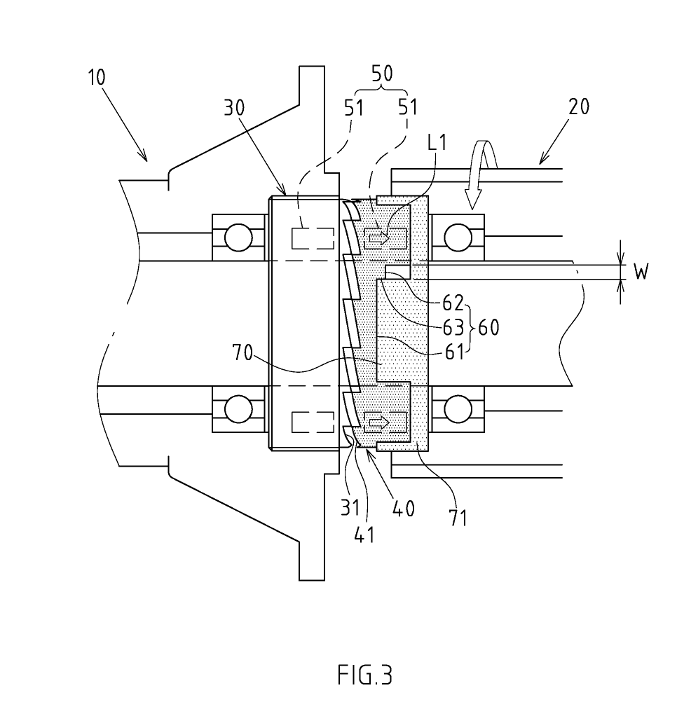

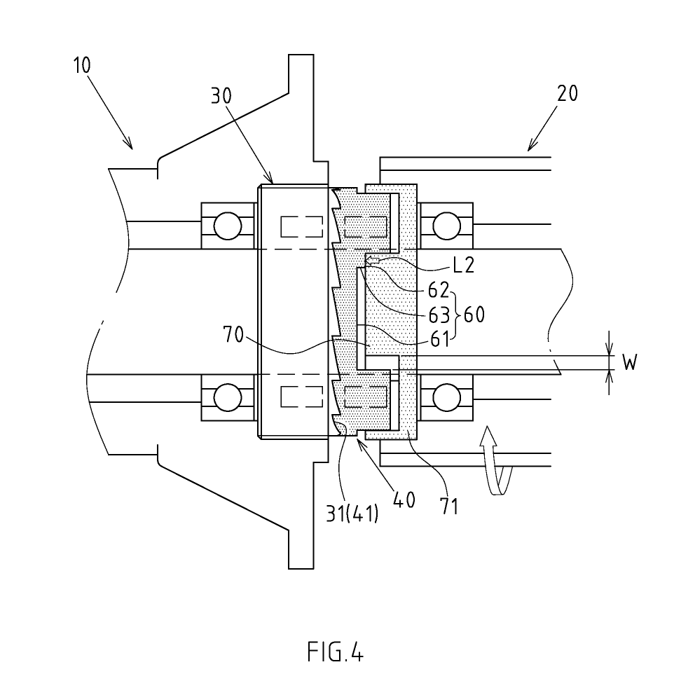

Referring to the drawings and initially to FIGS. 1 and 2, an anti-slip device A for a hub of a bicycle in accordance with the present invention is provided for a first engaging element 30 and a second engaging element 40 between a bicycle hub 10 and a chain wheel drive seat 20 of the bicycle, wherein the first engaging element 30 and the second engaging element 40 respectively include a first teethed face 31 and a second teethed face 40 that are exactly engaged to each other for driving the bicycle hub 10. The first engaging element 30 is mounted onto one side of the bicycle hub 10 and the second engaging element 40 is axially movably received in the chain wheel drive seat 20, wherein the second engaging element 40 is automatically engaged to the first engaging element 30 due to a resume structure 50 that is disposed between the first engaging element 30 and the second engaging element 40. The second engaging element 40 has one side facing the chain wheel drive seat 20 and including indentations 60 equally defined therein. Each indentation 60 has a bottom 61 and a protrusion (not numbered) extending from one end of the bottom, wherein the protrusion has a shoulder 62 and a distal end 63. The chain wheel drive seat 20 has multiple curved control blocks 70 laterally extending therefrom, wherein the multiple curved control blocks 70 are annularly arranged. With reference to FIGS. 3 and 4, each curved control block 70 is movably received in a corresponding one of the indentations 60 and a circle difference is formed between the corresponded curved control block 70 and the indentation 60. A top of the curved control block 70 abuts against the bottom 61 of the corresponding indentation 60 and engaged to the distal end 63 of the protrusion when the first teethed face 31 of the first engaging element 30 and the second teethed face 41 of the second engaging element 40 are dislocated and the second engaging element 40 is backward moved relative to the first engaging element 30. The top of the curved control block 70 is disengaged from the distal end 63 and moved along the circle difference W to engaged to the shoulder 62 such that the second engaging element 40 cannot be backward moved relative to the first engaging element 30 when the second teethed face 41 is engaged to the first teethed face 31 to prevent the bicycle hub 10 from being idle.

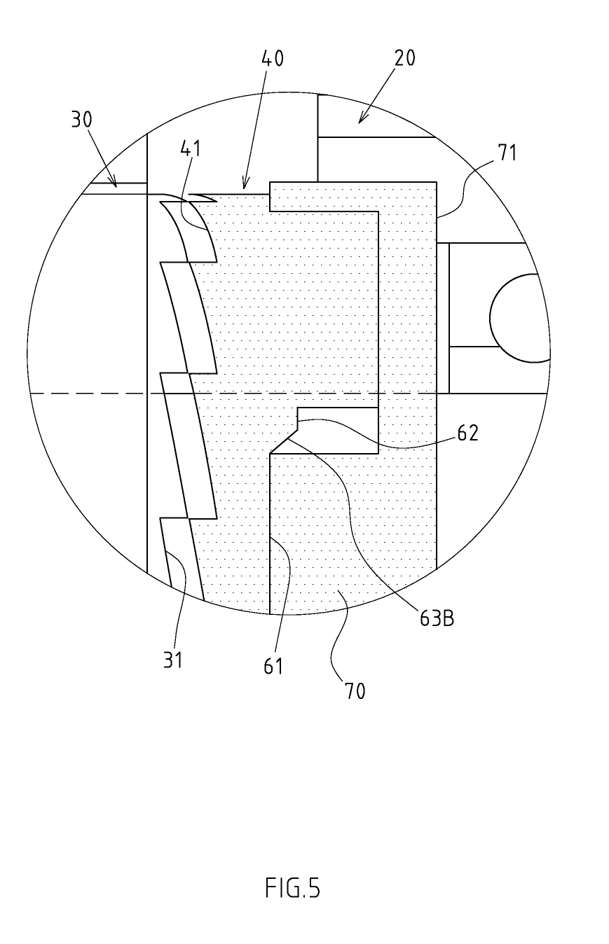

With reference to FIGS. 3 and 4, the distal end 63 is vertical relative to the bottom 61 of the indentation 60. With reference to FIG. 5, the distal end 63B is inclined relative to the bottom 61 of the indentation.

With reference to FIGS. 1 and 2, the curved control blocks 70 are formed on threaded ring 71 and the threaded ring 71 is co-axially screwed into the chain wheel drive seat 20.

The indentations 60 and the corresponding curved control blocks 70 can be exchanged and the exchanged indentations 60 and curved control blocks 70 can achieve the same function.

With reference to FIGS. 3 and 4, the resume structure 50 between the first engaging element 30 and the second engaging element 40 includes multiple magnets 51 that are respectively mounted into the first engaging element 30 and the second engaging element 40.

The resume structure 50 between the first engaging element 30 and the second engaging element 40 is spring that has two opposite ends respectively push the second engaged element 40 and the chain wheel drive seat 20.

As described above, the anti-slip device for a hub of a bicycle in accordance with the present invention includes the indentation 60 formed with the bottom 61, the shoulder 62 and the distal end 63, and the curved control block 70 movably received in the indentation. Consequently, The top of the curved control block 70 is disengaged from the distal end 63 and moved along the circle difference W to engaged to the shoulder 62 such that the second engaging element 40 cannot be backward moved relative to the first engaging element 30 when the second teethed face 41 is engaged to the first teethed face 31 to prevent the bicycle hub 10 from being idle.

Although the invention has been explained in relation to its preferred embodiment, it is to be understood that many other possible modifications and variations can be made without departing from the spirit and scope of the invention as hereinafter claimed.

I claim:

1. An anti-slip device for a hub of a bicycle, provided for a first engaging element and a second engaging element between a bicycle hub and a chain wheel drive seat of the bicycle, wherein the first engaging element and the second engaging element respectively include a first teethed face and a second teethed face that are exactly engaged to each other for driving the bicycle hub, the first engaging element mounted onto one side of the bicycle hub and the second engaging element axially movably received in the chain wheel drive seat, wherein the second engaging element is automatically engaged to the first engaging element due to a resume structure that is disposed between the first engaging element and the second engaging element, wherein the improvements comprises:
the second engaging element having one side facing the chain wheel drive seat and including indentations equally defined therein, each indentation having a bottom and a protrusion extending from one end of the bottom, wherein protrusion has a shoulder and a distal end, the chain wheel drive seat having multiple curved control blocks laterally extending therefrom, wherein the multiple curved control blocks are annularly arranged, each curved control block movably received in a corresponding one of the indentations and a circle difference formed between the corresponded curved control block and the indentation, whereby a top of the curved control block abuts against the bottom of the corresponding indentation and engaged to the distal end of the protrusion when the first teethed face of the first engaging element and the second teethed face of the second engaging element are dislocated and the second engaging element is backward moved relative to the first engaging element, and the top of the curved control block is disengaged from the distal end and moved along the circle difference to engaged to the shoulder such that the second engaging element cannot be backward moved relative to the first engaging element when the second teethed face is engaged to the first teethed face to prevent the bicycle hub from being idle.

2. The anti-slip device as claimed in claim 1, wherein the distal end is vertical relative to the bottom of the indentation.

3. The anti-slip device as claimed in claim 1, wherein the distal end is inclined relative to the bottom of the indentation.

4. The anti-slip device as claimed in claim 2, wherein the curved control blocks are formed on threaded ring and the threaded ring is co-axially screwed into the chain wheel drive seat.

5. The anti-slip device as claimed in claim 3, wherein the curved control blocks are formed on threaded ring and the threaded ring is co-axially screwed into the chain wheel drive seat.

6. The anti-slip device as claimed in claim 4, wherein the resume structure between the first engaging element and the second engaging element includes multiple magnets that are respectively mounted into the first engaging element and the second engaging element.

7. The anti-slip device as claimed in claim 5, wherein the resume structure between the first engaging element and the second engaging element includes multiple magnets that are respectively mounted into the first engaging element and the second engaging element.
